(19) United States
(12) Patent Application Publication
(10) Pub. No.: US 2004/0085552 A1
(43) Pub. Date: May 6, 2004

(54) Digital printing apparatus

(75) Inventor: Satoshi Ueda, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/694,175

(22) Filed: Oct. 28, 2003

(30) Foreign Application Priority Data
Oct. 28, 2002 (JP) 2002-312596

(51) Int. Cl. G06K 1/00; G06F 15/00

(52) U.S. Cl. 358/1.2; 358/1.9

(57) ABSTRACT

A digital printing apparatus improves the precision of a requisite printing time to be announced to a user, and the user can be informed of a correct required time. The image data read from a medium reading device is processed by a transfer image generation device, transferred to each of printers, and printed in the settings of a specified type of print, a print size, etc. A printing progress detection device monitors the status of the printing process on each of the printers, and a printing time computation device constantly computes the remaining requisite printing time and displays the result on a display device.

### BACKGROUND OF THE INVENTION

1. Field of the Invention

The present invention relates to a digital printing apparatus for printing image data read from a recording medium.

2. Description of the Related Art

A method of printing image data captured by a digital camera is to utilize a digital printing apparatus marketed and put on a shop. The digital printing apparatus put on a shop can automatically perform a printing process according to necessary items for printing that are taken from a recording medium inserted into the printing apparatus when a predetermined fee is deposited.

The printing system of the digital printing apparatus can be a TA (thermo-autochrome) system, a sublimation system, or an ink jet system. However, when a plurality of color image prints are required, it takes a certain time.

Japanese Patent Application Publication No. 2001-117747 discloses a digital printing apparatus which is provided with a plurality of printers and offers a high-speed printing service by a simple operation for selectively reading an image from a number of recording media, and quickly printing the image. In most cases, the above-mentioned digital printing apparatus estimates a requisite printing time in advance before starting the printing process and displays it to the user. However, the estimated requisite printing time contains considerable error, and no method of computing a correct estimated value is described.

### SUMMARY OF THE INVENTION

The present invention has been developed to solve the above-mentioned problems and aims at providing a digital printing apparatus for improving the precision of a requisite printing time to be announced to the user, and notifying a user of a correct required time.

The invention according to the first aspect is a digital printing apparatus including: a data reading device which can read image data from plural types of recording media; a setting device which sets at least one of the number of prints, types of prints, and a print size; a display device which displays contents set by the setting device; a printing image data generation device which generates printing image data based on the contents set by the setting device from the image data read by the data reading device; at least one printer; a transfer device which transfers to the printer the printing image data generated by the printing image data generation device; a computation device which computes a requisite printing time for contents of a print set by the setting device from at least a type of image format of image data stored in the recording medium, a print size, and the number of printers; and an execution instruction device which can perform printing execution instruction after displaying the requisite printing time computed by the computation device on the display device.

In the invention according to the first aspect, the data reading device reads image data from various types of recording media, the setting device sets the number of prints, the types of prints such as multiple printing, index printing, normal printing, etc., a print size such as an L size (89×127 mm), a 2L size (127×178 mm), a King size (4×6 inch), etc., the display device such as a liquid crystal display, etc. displays the contents set by the setting device, and the printing image data generation device generates printing image data by performing image processing, etc. such as color conversion, etc., and transfers generated printing image data to at least one printer.

The computation device computes a requisite printing time for the set contents of a print from the type of image format such as JPEG, TIFF, BMP, etc., a print size, the number of printers. The computed requisite printing time is displayed on the display device, and the user sees the display and determines whether or not the printing process is to be performed by the execution instruction device.

The invention according to the second aspect is a digital printing apparatus including: a data reading device which can read image data from plural types of recording media; a setting device which sets at least one of the number of prints, types of prints, and a print size; a display device which displays contents set by the setting device; a printing image data generation device which generates printing image data based on the contents set by the setting device from the image data read by the data reading device; a plurality of printers; a printer selection device which selects an available printer from among the plurality of printers; a transfer device which transfers to the printer selected by the printer selection device the printing image data generated by the printing image data generation device; a computation device which computes a requisite printing time for contents of a print set by the setting device from at least a type of image format of image data stored in the recording medium, the print size, and the number of printers; and an execution instruction device which can perform printing execution instruction after displaying the requisite printing time computed by the computation device on the display device.

The invention according to the second aspect includes a plurality of printers based on the first aspect. The printer selection device selects an available printer from a plurality of printers. The transfer device transfers the generated printing image data to the printer selected by the printer selection device. Other operations are the same as those described in the first aspect of the present invention.

The invention according to third aspect is a digital printing apparatus based on the first aspect or the second aspect, wherein the computation device computes a requisite printing time for the contents of a print set by the setting device further from the types of recording media.

According to the third aspect of the present invention, considering that the image data reading speed of the data reading device depends on the type of recording medium, the computation device computes the requisite printing time further from the type of recording medium.

The invention according to fourth aspect is the digital printing apparatus based on the first aspect or the second aspect. With the above-mentioned configuration, the computation device computes a requisite printing time for the contents of a print set by the setting device further from the types of print services.

In the invention according to the fourth aspect, since the printing time can depend on the type of print service, that is, the multiple printing, the index printing, the normal printing, etc., the computation device computes the requisite printing time for the contents of a print set by the setting device further from the type of print service.

The invention according to fifth aspect is the digital printing apparatus based on the first aspect or the second aspect. With the configuration, the requisite printing time includes a time required to read image data from the data reading device, a time required to generate printing image data by the printing image data generation device, a printing image data transfer time by the transfer device and a printing time by the printer.

In the invention according to the fifth aspect, the digital printing apparatus computes the requisite printing time from the time required to read image data by the data reading device, the time required to generate the printing image data by the printing image data generation device, and the time required to transfer the printing image data by the transfer device, and the printing time by the printer. Therefore, the requisite printing time can be correctly computed by precisely computing the time of each element.

The invention according to sixth aspect is the digital printing apparatus based on the first aspect or the second aspect. With the configuration, during printing, the computation device detects a printing execution progress, constantly computes remaining requisite printing time, and displays the computed remaining requisite printing time on the display device.

In the invention according to the sixth aspect, the time obtained by subtracting the time required to perform the printing process from the initially computed requisite printing time is not displayed on the display device, but, during the printing, the computation device monitors the printing progress up to the current time point by detecting the printing progress, thereby constantly computing the remaining requisite printing time and displaying it on the display device.

According to the first aspect of the present invention, the user can be informed of the correct requisite printing time in addition to the order contents before performing the printing process. Therefore, the printing process can be performed according to the original schedule, or can also stop the process depending on the current situation in time. Additionally, since the user can be informed of the correct requisite printing time, the user can be away for another job in the shop. Furthermore, the user can correctly determined whether or not the printing process is to be performed immediately before the shop in which the digital printing apparatus is mounted is closed, thereby closing the shop at a predetermined time. This is a good invitation to the purchase of the digital printing apparatus in a shop. Furthermore, since a person working for a company can correctly determine whether or not the printing process can be completed at lunchtime in the company, he or she can be free of being nervous about the printing process.

According to the second aspect of the present invention, there can be a plurality of printers. Therefore, the user can quickly perform the printing process using the entire printing apparatuses in addition to the effects of the first aspect of the present invention.

According to the third aspect of the present invention, a requisite printing time can be more correctly computed.

According to the fourth aspect of the present invention, a requisite printing time can be furthermore correctly computed.

According to the fifth aspect of the present invention, the requisite printing time can be correctly computed by precisely computing the time for each of the predetermined elements. Therefore, the correct requisite printing time can be more easily computed.

According to the sixth aspect of the present invention, the remaining printing time can be constantly recomputed based on the current printing progress, and the recomputed remaining requisite printing time can be displayed on the display device. Therefore, the display device can display a correct remaining requisite printing time.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is an oblique view of the appearance of the digital printing apparatus;

FIG. 2 is a block diagram showing the hardware configuration of the digital printing apparatus;

FIG. 3 shows the sequence of the printing process;

FIG. 4 shows the display screen of the display/selection device showing the contents of settings;

FIG. 5 shows the display screen of the display/selection device during printing;

FIG. 6 shows the unit size processing time of an image for each image format; and

FIG. 7 shows the planned printing time for each print size.

### DETAILED DESCRIPTION OF THE PREFERRED EMBODIMENTS

The preferred embodiments of the digital printing apparatus according to the present invention are described below in detail by referring to the attached drawings.

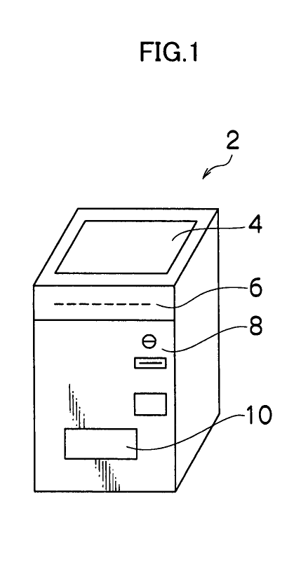

FIG. 1 is an oblique view of the appearance of the digital printing apparatus 2 according to the present invention. The digital printing apparatus 2 is the type marketed on display. The user carries a recording medium such as SmartMedia storing image data -captured by a digital camera, etc., and inserts the recording medium into a medium slot 6. There are a plurality of medium slots 6 for use of several types of recording media such as CompactFlash, MemoryStick, etc. in addition to SmartMedia.

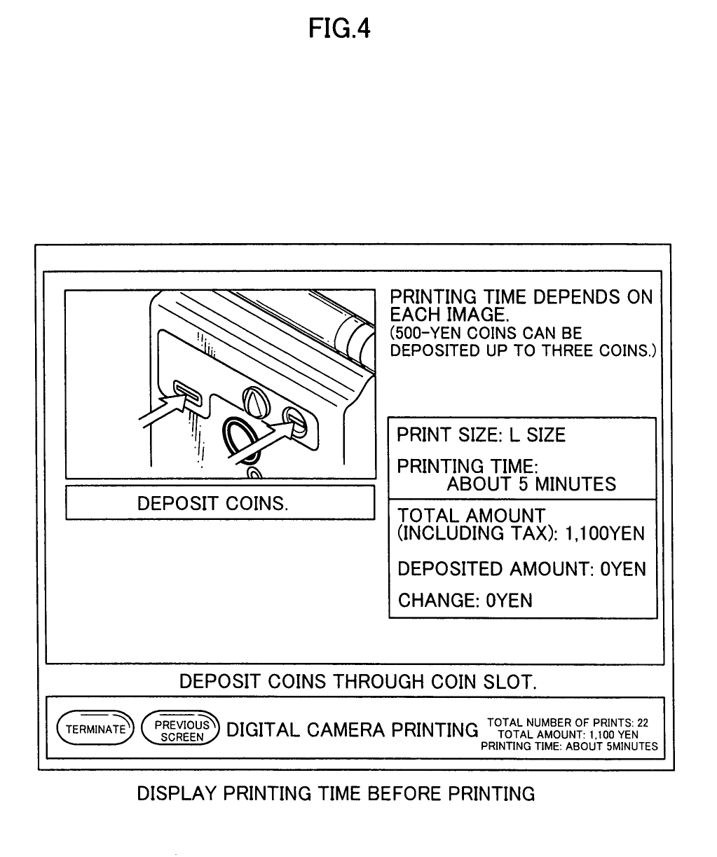

A display/selection device 4 is mounted on the top surface. The display/selection device 4 sets the printing details such as the number of prints, the types of prints, the print size, etc., and the set contents are displayed on the display/selection device 4. The display/selection device 4 can be, for display, a touch-type liquid crystal panel. As shown in FIG. 4, the display/selection device 4 displays an amount, a requisite printing time, etc. for set contents, and the user deposits money into an accounting device 8 and waits for a print of a digital image stored in the recording medium. During the printing, the screen as shown in FIG. 5 is displayed, and the constantly computed remaining requisite printing time and the printing progress are displayed. The printing system can be a TA system, a sublimation system, an ink jet system, etc.

A finished print is fed at an outlet 10 each time it is finished, and the user takes it.

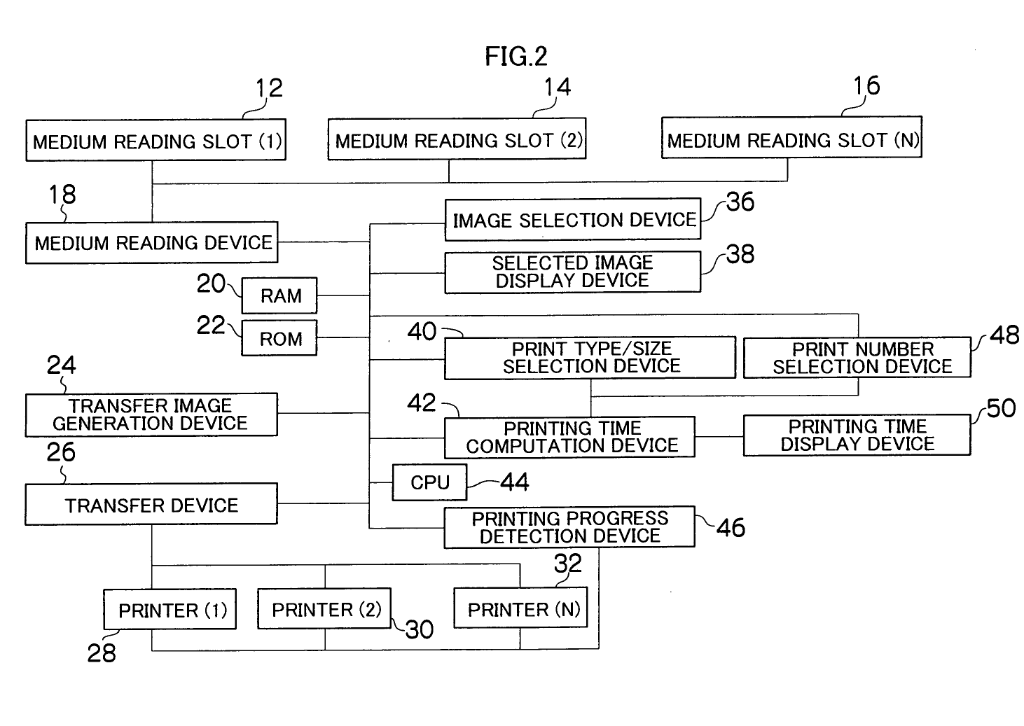

Described below is the configuration of the hardware of the digital printing apparatus 2. FIG. 2 is a block diagram of the configuration of the hardware of the digital printing apparatus 2.

The user inserts a recording medium into the medium slot 6 (FIG. 2). There are provided a number of medium reading slots for a number of recording medium types, that is, a medium reading slot (1) 12, a medium reading slot (2) 14, . . . , and a medium reading slot (n) 16. Each of the medium reading slots 12, 14, and 16 is connected to a medium reading device 18, and the medium reading device 18 reads image data from the recording medium inserted into each of the medium reading slots 12, 14, and 16.

The image data is read at an instruction of a CPU 44 from a thumbnail image of each image file, and settings are made such that a user can select a desired image. That is, a thumbnail image list of thumbnail images of each image file is displayed is displayed on the display/selection device 4, a user selects a desired image for a print from the display on the display/selection device 4, and an image selection device 36 connected to the display/selection device 4 converts the image into selection information. The selection information is transmitted to a selected image display device 38, and the selected image is displayed on the display/selection device 4 connected to the selected image display device 38. When there are a plurality of images to be printed, a series of hardware operations are performed each time the user selects a print image from the display/selection device 4.

The user sets the types of prints, the print size, the number of prints through the display/selection device 4, and the setting contents are converted into the setting information by a print type/size selection device 40 and a print number selection device 48. The setting information is transmitted to the selected image display device 38, and the setting contents are displayed on the display/selection device 4 connected to the selected image display device 38.

The types of prints refer to multiple printing, index printing, normal printing, etc. The print size refers to a card size, an L size, a 2L size, a King size (4×6 inch), etc.

At this time, the requisite printing time for the set contents are computed by a printing time computation device 42, and the computed time is converted into time information by a printing time display device 50, and displayed on the display/selection device 4. The amount for the set contents is also computed by the CPU 44, and the results are displayed on the display/selection device 4. The method of computing the requisite printing time is described later. The display screen is shown in FIG. 4.

When the user confirms the set contents, and determines that a print can be made, the user deposits the fee into the accounting device 8, and presses the execution button (not shown in FIG. 4).

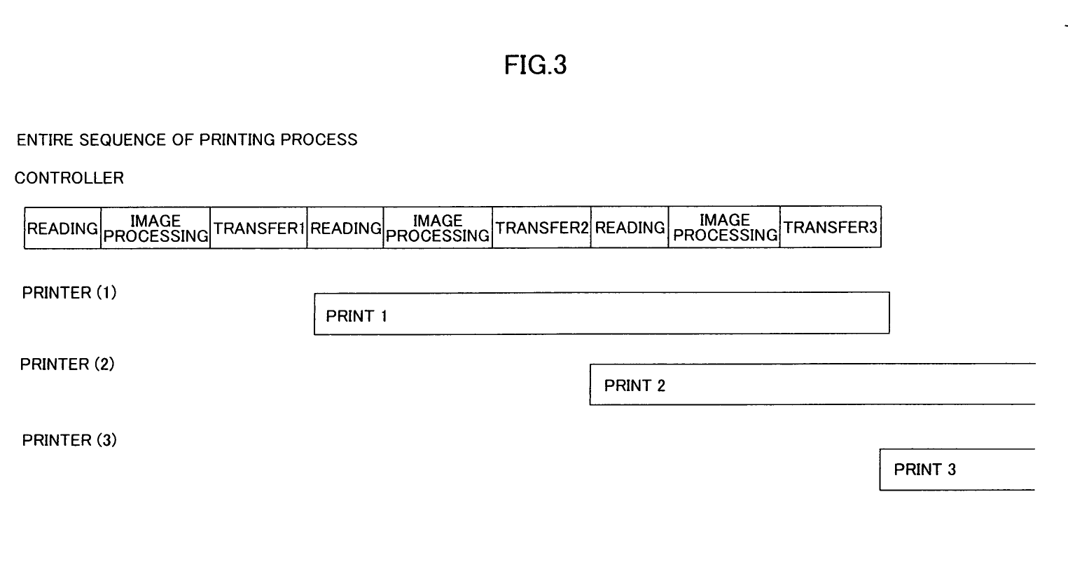

When the execution button is pressed, the printing process is started. FIG. 3 shows the sequence of the printing process.

First, the medium reading device 18 reads image data in the recording medium specified for the printing process. The image data stored in the recording medium is in the format of the JPEG, the TIFF, the BMP, etc., but image data in any format can be read. The read data is temporarily stored in RAM 20. When it is read, compressed data is decompressed. The image data is stored in the decompressed state in the RAM 20.

Then, the image data is processed in the color conversion process by RGB conversion and 3D conversion by a transfer image generation device 24.

The control program for decompressing data and image processing is stored in ROM 22, and the control program is activated at an instruction of the CPU 44.

After the image processing, the image data is transferred to a transfer device 26. The transfer device 26 further transfers the received image data to each printer as a printing job in a predetermined distribution method. In this embodiment, a printer (1) 28, a printer (2) 30, . . . , and a printer (N) 32 are provided for example. Each of the printers 28, 30, and 32 performs the printing job transferred to the printer.

Each of the printers 28, 30, and 32 is connected to a printing progress detection device 46. During the printing, the progress of the printing job of each of the printers 28, 30, and 32 is constantly detected by the printing progress detection device 46. That is, in each of the printers 28, 30, and 32, each time a printing job is completed, the printer which has completed its job transmits printing completion information to the printing progress detection device 46. When the printing progress detection device 46 receives the printing completion information, the printing progress information is transmitted to the printing time computation device 42, and the remaining requisite printing time is computed again. The recomputed remaining requisite printing time is displayed on the display/selection device 4 through the printing time display device 50. The display screen on the display/selection device 4 during the printing is shown in FIG. 5.

The printing sequence and the computation of the remaining requisite printing time are described below in detail.

For example, as shown in FIG. 3, when image data is read, image-processed, and completed in the process of a transfer 1 for the first print in the medium reading device 18 and the transfer image generation device 24 (hereinafter referred to as “controllers 18 and 24”), the completed printing job is transferred to the printer (1) 28. The printer (1) 28 receives the transferred printing job and immediately enters the operation of the print 1. When the printer (1) 28 completes a predetermined printing step on the print 1, it terminates the requisite printing time of the print 1.

After transferring the printing job of the print 1 to the printer (1) 28, the controllers 18 and 24 immediately read image data for the printing job of a print 2, perform the image processing and the process of a transfer 2, and transfer the results to the printer (2) 30. Upon receipt of the transferred printing job, the printer (2) 30 enters the operation of the print 2. When a predetermined printing step of the print 2 is completed, the printer (2) 30 terminates the printing step of the print 2.

If there is a printer (3), and it is a printer (3) 31, then the controllers 18 and 24 transfer the printing job of the print 2 to the printer (2) 30, immediately read the image data for the printing job of a print 3, perform the image processing and the process of a transfer 3, and transfer the results to the printer (3) 31. Upon receipt of the transferred printing job, the printer (3) 31 immediately enters the operation of the print 3. When the printer (3) 31 completes a predetermined printing step of the print 3, it terminates the printing step of the print 3.

Described below is an expression of a requisite printing time. The total printing time is given by the following equation (1):

$$\begin{matrix}Total printing time = Entire image generating time + \\ \frac{Total number of prints \times Printing time}{Number of printers} ,\end{matrix} \qquad ( 1 )$$

where Entire image generating time=Image 1 generating time+Image 2 generating time+ . . . , and the image generating time refers to the time required to generate the above-mentioned printing job and is given by:

Image generating time=Image data reading time+Image processing time+Transfer time.

A predetermined parameter or a predetermined value of each of the image data reading time, the image processing time, and the transfer time is set.

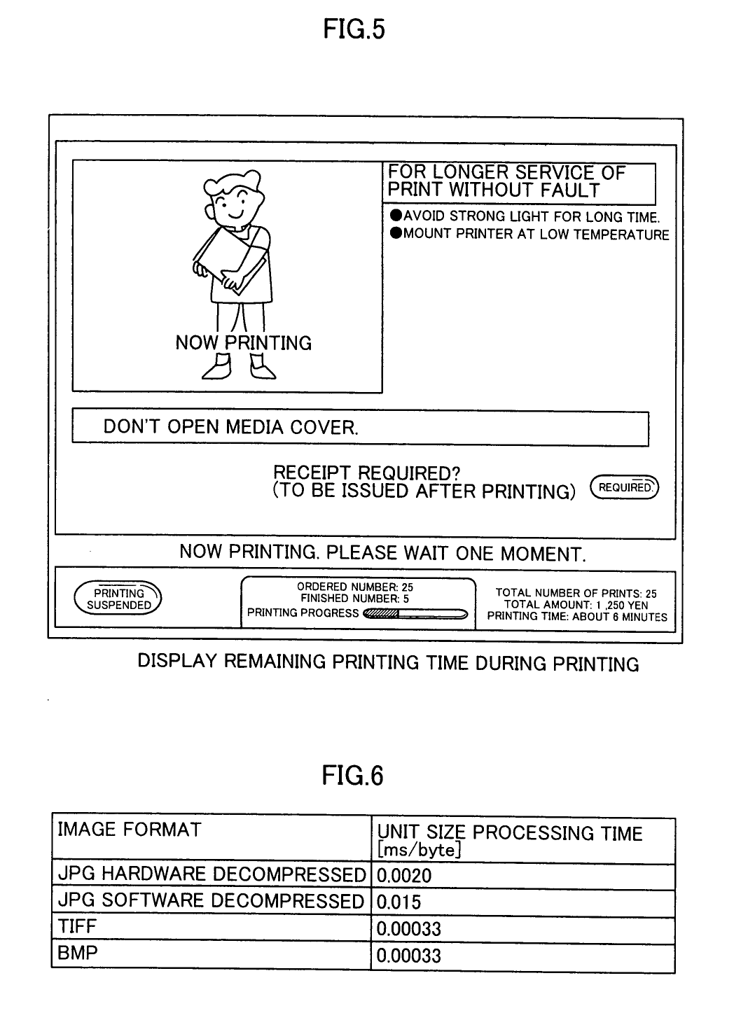

For example, there can be four sorts of image generating times in the image format as shown in FIG. 6. Common parameters are used for the print type, print size and the media type. In this example, the 1 image data generating time is equal to the L size 1-image generating time, and the unit size processing time by a file size is set as a parameter. The 1 image data generating time may be equal to the King size 1-image generating time, and the unit size processing time by a file size is set as a parameter. However, for example, a unit size processing time can be set for each type of print, each print size, and each recording medium.

For the image size, a color conversion time is determined for each size. The computing method in recomputation is similar to the equation (1).

The transfer time is determined by a unit size transfer time, and is 0.000503 (ms/byte).

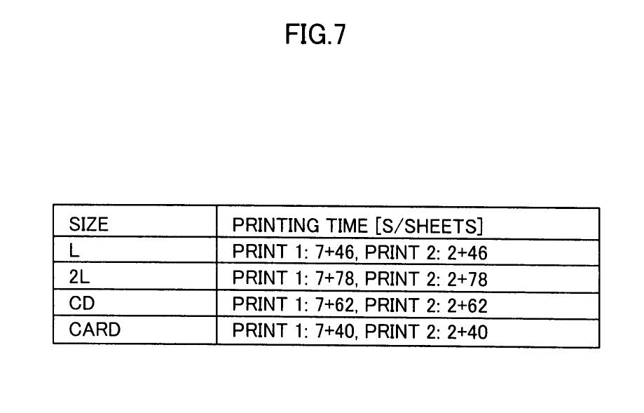

The printing time is predetermined by a print size, that is, the L size, the 2L size, the King size, the CD size, the card size, etc. An estimated printing time for each size is shown in FIG. 7.

In the example above, the printer enters a printing operation immediately after a printing job is transferred to each printer. However, when there is a time lag until the printing operation starts after the transfer of a job, the printing time can be set with the time lag taken into account.

On the other hand, if the previous printing job is being processed when a printing job is transferred, a predetermined value can be added as a printing time after the completion of the previous printing job.

Furthermore, when a printer is announced as an erroneous device when a printing job is transferred to the printer, the printing progress detection device 46 detects the occurrence of an error of a printer. Therefore, the total printing time is recomputed by the expression of a printing time given by the equation (1) from the number of printers in operation, and the result is displayed on the display/selection device 4.

After the start of the printing process, the remaining time required to perform the printing process is computed at the above-mentioned timing. Therefore, if there occurs a change in the estimated remaining printing time during the printing, the remaining time is amended and displayed on the display/selection device 4, thereby constantly displaying the correct remaining requisite printing time.

According to the present embodiment, a plurality of printers are mounted. However, there can be a single printer mounted according to the present invention.

The digital printing apparatus according to the present embodiment notifies the user of a correct requisite printing time before performing a printing process. Therefore, the user can optionally determine whether or not the printing process is to be performed.

Furthermore, since the user can be informed of a correct requisite printing time, the user can perform another job, and can also determine whether or not the printing process is to be performed immediately before his or her shop in which the digital printing apparatus is mounted is closed, thereby closing the shop at a predetermined closing time.

For a person working for a company or a shop, he or she can correctly determine whether or not the image processing can be completed at lunchtime, and can be free of being nervous about the printing.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A digital printing apparatus, comprising:
a data reading device which can read image data from plural types of recording media;
a setting device which sets at least one of the number of prints, types of prints, and a print size;
a display device which displays contents set by the setting device;
a printing image data generation device which generates printing image data based on the contents set by the setting device from the image data read by the data reading device;
at least one printer;
a transfer device which transfers to the printer the printing image data generated by the printing image data generation device;
a computation device which computes a requisite printing time for contents of a print set by the setting device from at least a type of image format of image data stored in the recording medium, a print size, and the number of printers; and
an execution instruction device which can perform printing execution instruction after displaying the requisite printing time computed by the computation device on the display device.

2. The digital printing apparatus according to claim 1, wherein the computation device computes a requisite printing time for contents of a print set by the setting device further from types of recording media.

3. The digital printing apparatus according to claim 1, wherein the computation device computes a requisite printing time for contents of a print set by the setting device further from types of print services.

4. The digital printing apparatus according to claim 1, wherein the requisite printing time comprises a time required to read image data from the data reading device, a time required to generate printing image data by the printing image data generation device, a printing image data transfer time by the transfer device and a printing time by the printer.

5. The digital printing apparatus according to claim 1, wherein during printing, the computation device detects a printing execution progress, constantly computes remaining requisite printing time, and displays the computed remaining requisite printing time on the display device.

6. A digital printing apparatus, comprising:
a data reading device which can read image data from plural types of recording media;
a setting device which sets at least one of the number of prints, types of prints, and a print size;
a display device which displays contents set by the setting device;
a printing image data generation device which generates printing image data based on the contents set by the setting device from the image data read by the data reading device;
a plurality of printers;
a printer selection device which selects an available printer from among the plurality of printers;
a transfer device which transfers to the printer selected by the printer selection device the printing image data generated by the printing image data generation device;
a computation device which computes a requisite printing time for contents of a print set by the setting device from at least a type of image format of image data stored in the recording medium, the print size, and the number of printers; and
an execution instruction device which can perform printing execution instruction after displaying the requisite printing time computed by the computation device on the display device.

7. The digital printing apparatus according to claim 6, wherein the computation device computes a requisite printing time for contents of a print set by the setting device further from types of recording media.

8. The digital printing apparatus according to claim 6, wherein the computation device computes a requisite printing time for contents of a print set by the setting device further from types of print services.

9. The digital printing apparatus according to claim 6, wherein the requisite printing time comprises a time required to read image data from the data reading device, a time required to generate printing image data by the printing image data generation device, a printing image data transfer time by the transfer device and a printing time by the printer.

10. The digital printing apparatus according to claim 6, wherein during printing, the computation device detects a printing execution progress, constantly computes remaining requisite printing time, and displays the computed remaining requisite printing time on the display device.
